(19) United States
(12) Patent Application Publication
(10) Pub. No.: US 2026/0352471 A1
(43) Pub. Date: Nov. 5, 2026

(54) SYSTEMS AND METHODS FOR IMPLEMENTING ARTIFICIAL INTELLIGENCE ZERO-TRUST DATA QUALITY

(71) Applicant: JPMORGAN CHASE BANK, N.A., New York, NY (US)

(72) Inventor: James MASSA, Water Mill, NY (US)

(21) Appl. No.: 19/197,106

(22) Filed: May 2, 2025

(51) Int. Cl. H04L 9/32

(52) U.S. Cl. CPC H04L 9/3213; H04L 9/3236

(57) ABSTRACT

Systems and methods for implementing artificial intelligence zero-trust data quality are disclosed. A method may include: an initial policy enforcement point in a cloud computing environment receiving data from a data source, applying a first data quality ruleset to the data, quarantining data that is not validated by the first data quality ruleset, and generating a token for validated data that is validated by the first data quality ruleset, wherein the token comprises a checksum for the validated data and an identifier for the first data quality ruleset; a second policy enforcement point receiving, from a consuming computer program, a request for the validated data, retrieving the token, and determining from the identifier for the first data quality ruleset, that the validated data is valid for a second data quality ruleset, validating the checksum, and providing the validated data to the consuming computer program.

### BACKGROUND OF THE INVENTION

### 1. Field of the Invention

Embodiments relate to systems and methods for implementing artificial intelligence zero-trust data quality.

### 2. Description of the Related Art

With the increasing prevalence of Artificial Intelligence (“AI”), the importance of data quality (“DQ”) is becoming paramount to achieving reliable business results. Regulators are putting increasing emphasis on data quality, creating new regulations, and issuing fines to banks, including a for reporting incomplete trading data to surveillance platforms.

### SUMMARY OF THE INVENTION

Systems and methods for implementing artificial intelligence zero-trust data quality are disclosed. In one embodiment, a method may include: (1) receiving, at an initial policy enforcement point in a cloud computing environment, data from a data source; (2) applying, by the initial policy enforcement point, a first data quality ruleset to the data; (3) quarantining, by the initial policy enforcement point, data that is not validated by the first data quality ruleset; (4) generating, by the initial policy enforcement point, a token for validated data that is validated by the first data quality ruleset, wherein the token comprises a checksum for the validated data and an identifier for the first data quality ruleset; (5) receiving, by a second policy enforcement point and from a consuming computer program, a request for the validated data; (6) retrieving, by the second policy enforcement point, the token; (7) determining, by the second policy enforcement point and from the identifier for the first data quality ruleset, that the validated data is valid for a second data quality ruleset; (8) validating, by the second policy enforcement point, the checksum; and (9) providing, by the second policy enforcement point, the validated data to the consuming computer program.

In one embodiment, the checksum comprises a hash of the validated data.

In one embodiment, the step of validating the checksum may include generating, by the second policy enforcement point, a second checksum on the validated data; and validating, by the second policy enforcement point, that the checksum and the second checksum are the same.

In one embodiment, the token further comprises an assessment of a data quality of the validated data.

In one embodiment, the second data quality ruleset is newer than the first data quality ruleset.

In one embodiment, the method may also include: receiving, by the initial policy enforcement point and the second policy enforcement point, explainability weights for the second data quality ruleset; and updating, by the initial policy enforcement point and the second policy enforcement point, data quality checks of attributes in the data based on the explainability weights.

In one embodiment, the explainability weights impact an amount of time for each data quality check.

In one embodiment, the method may also include: applying, by the second policy enforcement point, the second data quality ruleset to the validated data; quarantining, by the second policy enforcement point, validated data that is not validated by the second data quality ruleset; and providing, by the second policy enforcement point, the validated data that is validated by the second data quality ruleset to the consuming computer program.

According to another embodiment, a method may include: (1) receiving, by a computer program, computer code; (2) prompting, by the computer program, a large language mode (LLM) to review the computer code for instances of inclusionary filtering logic; (3) prompting, by the computer program, the LLM to replace the instances of inclusionary filtering logic in the computer code with exclusionary filtering logic, wherein the LLM replaces the instances of inclusionary filtering logic in the computer code with exclusionary filtering logic resulting in updated computer code; and (4) receiving, by the computer program, the updated computer code from the LLM.

In one embodiment, the method may also include: prompting, by the computer program, the LLM to validate the updated computer code to ensure that an overall functionality of the computer code is not changed.

In one embodiment, the computer code is received as part of a deployment pipeline.

In one embodiment, the method may also include: committing, by the computer program, the computer code from the LLM to a code repository.

According to another embodiment, a method may include: (1) receiving, by an initial policy enforcement point, source data; (2) applying, by the initial policy enforcement point, a first data quality ruleset to the source data; (3) quarantining, by the initial policy enforcement point, source data that is not validated by the first data quality ruleset as first quarantined data; (4) reviewing, by an exclusion point, source data that is validated by the first data quality ruleset; (5) excluding, by the exclusion point, a subset of the validated source data as excluded data; (6) applying, by a second policy enforcement point, a second set of data quality rules to validated data that is not excluded data; (7) quarantining, by the second policy enforcement point, validated source data that is not excluded data that is not validated by the second data quality ruleset as second quarantined data; (8) providing, by the second policy enforcement, the validated source data that is not excluded data as target data; (9) validating, by an independent reconciliation process virtual layer, that the source data minus the first quarantined data, the excluded data, and the second quarantined data equals the target data; and (10) generating by the independent reconciliation process virtual layer, a reconciliation report based on the validation.

In one embodiment, the method may also include writing, by the independent reconciliation process virtual layer, the reconciliation report to a blockchain.

In one embodiment, the reconciliation report comprises a report of all data rows in the source data and what was done with each row.

In one embodiment, the exclusion point comprises an extract-transfer-load exclusion point.

In one embodiment, the exclusion point executes exclusion logic to exclude the subset of the validated data.

### BRIEF DESCRIPTION OF THE DRAWINGS

For a more complete understanding of the present invention, the objects, and advantages thereof, reference is now made to the following descriptions taken in connection with the accompanying drawings in which:

FIG. 1 illustrates a system for implementing artificial intelligence zero-trust data quality according to an embodiment;

FIG. 2 illustrates a method for implementing artificial intelligence zero-trust data quality according to an embodiment;

FIG. 3 illustrates a method for checking code for exclusionary filtering logic according to an embodiment;

FIG. 4 illustrate a method for automatic data quality impact assessment and response according to an embodiment;

FIG. 5 illustrates a method for automatic sustainability according to an embodiment;

FIG. 6 illustrates a method for automatic blockchain results storage decisioning according to an embodiment;

FIG. 7 illustrates a method for independent automatic data completeness checks is disclosed according to an embodiment; and

FIG. 8 depicts an exemplary computing system for implementing aspects of the present disclosure.

### DETAILED DESCRIPTION OF PREFERRED EMBODIMENTS

Embodiments relate to systems and methods for implementing artificial intelligence zero-trust data quality.

Embodiments may leverage the explainability weights of AI models to improve the performance of data quality checks, making it feasible to check data quality before every data usage. This guarantees that only high-quality data is used in analytics.

Embodiments may apply frameworks, tools, and concepts from the AI and cybersecurity domains to the data quality domain. For example, from the AI domain, embodiments may leverage LLM and AI explainability weights to automatically determine the exact importance of data quality at attribute level and drive DQ automation at attribute level. From the cybersecurity domain, embodiments may leverage the zero-trust concept, security tokens, and the NIST Cybersecurity 2.0 framework.

Before code is deployed, embodiments may review the code with an LLM agent to ensure that it does not allow silent data quality errors. If problematic code is detected, it automatically fixes it. Post-deployment, embodiments may automatically execute an independent reconciliation between data producers and data consumers to ensure data completeness at data row level and data accuracy at data attribute level.

Embodiments may use the explainability weights output from AI models, and automated LLM code reviews of analytical tools, to automatically assess the risk of a potential data quality issue for each attribute and to automatically calibrate the level of data validation needed based upon the risk vs. performance and cost trade-off.

Embodiments may score the results of data quality check runs in a token alongside the actual data. Before each usage of the data, the token can be validated to ensure that the data is of high quality for the specific purpose.

Embodiments makes it feasible to implement zero trust data quality, where data quality may be tested before every time data is persisted or used. For example, embodiments may check the token before each data usage, whereas doing a full data quality check takes a long time, making it impractical to use before each data usage.

Embodiments may calibrate performance to maximize data validation within the available service level agreement time and to minimize cost, so that data quality is checked before it is persisted.

Embodiments may prevent silent data completeness issues pre-deployment by automatically reviewing code with an LLM agent to identify cases of data pipelines that use inclusion logic rather than exclusively using exclusion logic.

Post-deployment at runtime, embodiments may row level data completeness and attribute level data accuracy through an independent reconciliation process between the source system-of-record and the ultimate data consumer. The independent process ensures that the reconciliation does not duplicate issues in the extract-transfer-load (ETL). It also allows comparison between the data's origination point and its final resting place regardless of how many hops there may be in the data lineage.

The reconciliation immediately determines whether there are differences using a hashing algorithm. If there are differences, then embodiments may identify exactly what is different.

Embodiments may provide reconciliation in a virtual layer. For example, reconciliation is done through a virtual SPARK layer so that the input data does not need to be replicated to a central location. The output may be stored on an immutable blockchain so that it be evidenced to regulators in the future.

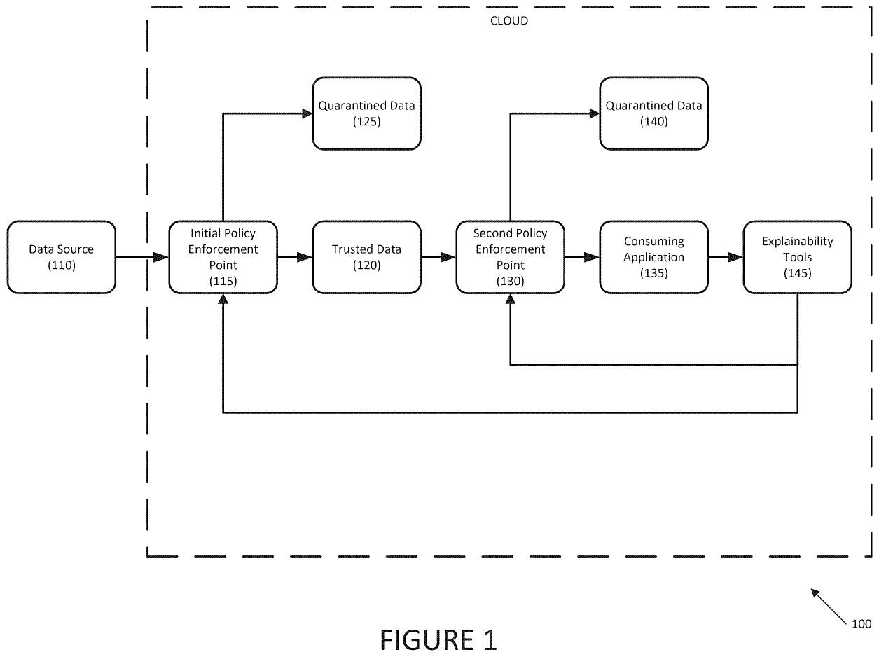

Referring to FIG. 1, a system for implementing artificial intelligence zero-trust data quality is disclosed according to an embodiment. System 100 may include data source 110, which may provide data that may be ingested. The data may be received at initial policy enforcement point 115. Initial policy enforcement point 115 may validate the data by applying a data quality ruleset to the data. Data that passes the data quality ruleset validation may become trusted data 120, and data that does not pass the data quality ruleset validation may be quarantined data 125.

Initial policy enforcement point may generate a token for trusted data 120 that may stay with trusted data 120. The token may include a checksum for the trusted data (i.e., to show that the validated data has not changed since trusted), such as a hash or similar, an identifier for the version of the data quality ruleset that was used to validate the data, and the results of the data quality checks, including an overall assessment of the dataset's data quality. The results of the checks do not pass judgement or score the data quality. Instead, they precisely describe the data quality so that a consumer process can decide for itself whether the data is fit for purpose by reviewing the token.

System 100 may include consuming application 135, which may be an artificial intelligence or analytics application. Consuming application 135 may periodically request trusted data 120 from second policy enforcement point 130. Second policy enforcement point may retrieve the token associated with trusted data 120 and may determine whether the data quality ruleset applied by initial policy enforcement point are still valid. If they are, the trusted data may be consumed by consuming application 135. If not, second policy enforcement point 130 may apply an updated data quality ruleset to trusted data, and validated data may be consumed by consuming application 135. Trusted data that is not validated may be quarantined as quarantined data 140.

Explainability tools 145 may analyze data quality policies and may determine the bases for the data quality policies. Using the explainability tools 145, initial policy enforcement point 115 and second policy enforcement point 130 may be updated with a budget to spend on each element of the data quality ruleset based on the importance of each element in the data quality ruleset.

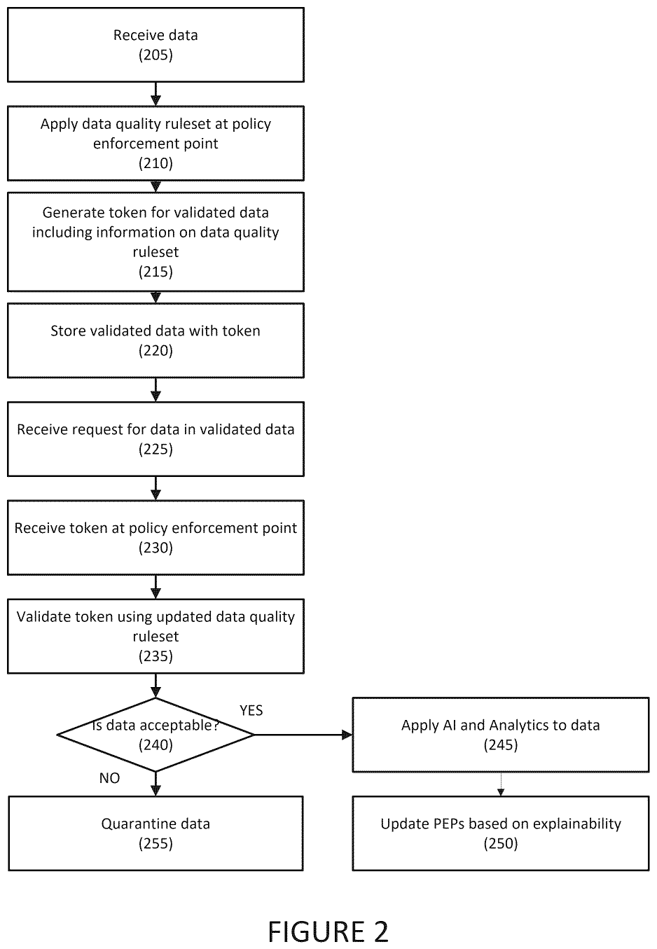

Referring to FIG. 2, a method for implementing artificial intelligence zero-trust data quality is disclosed according to an embodiment.

In step 205, an initial policy enforcement point may receive data from a data source.

In step 210, the initial policy enforcement point may apply a data quality ruleset to the data. Data that is not validated by the data quality ruleset may be Quarantined.

In one embodiment, the data quality ruleset may be weighted so that different attributes in the data are weighted differently. Thus, the policy enforcement point may allocate the time spent on reviewing the data for data quality based on the weightings (e.g., an attribute with a 20% weighting gets 20% of the review time, an attribute with a 5% weighting gets 5% of the review time, etc.). The weighting may be determined based on explainability, discussed below.

In step 215, the computer program may generate a token for the validated data following the application of the data quality ruleset. The token may include a checksum for the validated data (i.e., to show that the validated data has not changed since validation), such as a hash or similar, an identifier for the version of the data quality ruleset that was used to validate the data, and the results of the data quality checks, including an overall assessment of the dataset's data quality. The results of the checks do not pass judgement or score the data quality. Instead, they precisely describe the data quality so that a consumer process can decide for itself whether the data is fit for purpose by reviewing the token.

The token may include data quality results, such as a list of all data validations run and the results of those validations. Examples of data quality results may include an expected and actual row count, a manifest of all the attributes with a tag on those that failed checks for null values, out of range values, invalid enumeration values, invalid data types, etc., the time the data arrived vs. the SLA expected time, etc.

In step 220, the computer program may store the validated data with the token.

In step 225, the computer program may receive a request for the validated data from a consuming program, e.g., a computer program or application that will consume the validated data.

In step 230, the computer program may provide the token to a second policy enforcement point.

In step 235, the computer program may check the token to identify the version of the data quality ruleset that was run on the data. For example, the computer program may identify the version of the data quality ruleset in the token and may determine whether the data quality ruleset that was used to validate the data is valid for a consuming computer program or application. A new, or updated, consuming program may require a newer data quality ruleset than was run. In that case, a review of the token informs the consuming program that the data is not fit for purpose and that some or all of the consuming program functionality will be degraded.

The computer program may also examine a checksum in the token to ensure that the data has not changed since the quality was checked, i.e., the data quality results are still valid. If the data has changed, then a checksum, newly created will not match the checksum in the token. In that case, the data quality results cannot be relied upon because the underlying data has changed.

If, in step 240, the token is validated, in step 245, the computer program may apply AI and analytics to the validated data to identify explainability weights of the AI and analytics.

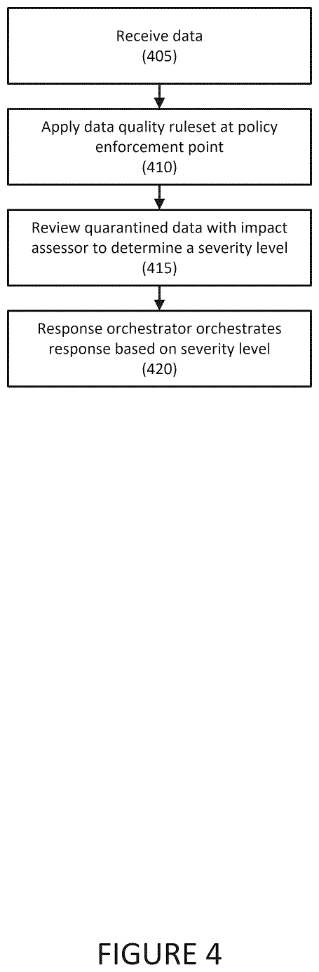

In step 250, the computer program may update the weightings of data quality checks in the data quality rulesets at the policy enforcement points, to be optimal, based on the explainability. Thus, the policy enforcement points may prioritize fuller check of key data elements (KDEs) and may prioritize AI features by LIME explainability weights. Other attributes may be sampled as lower rates. This is further described with regard to FIG. 4, below.

In step 255, if the token does not pass validation, then the data quality may be bad and the data may be quarantined, the data quality ruleset is old and a newer ruleset may be applied to all of the data and a new token created for that validation, or the data has changed and the full data set must be revalidated and a new token created.

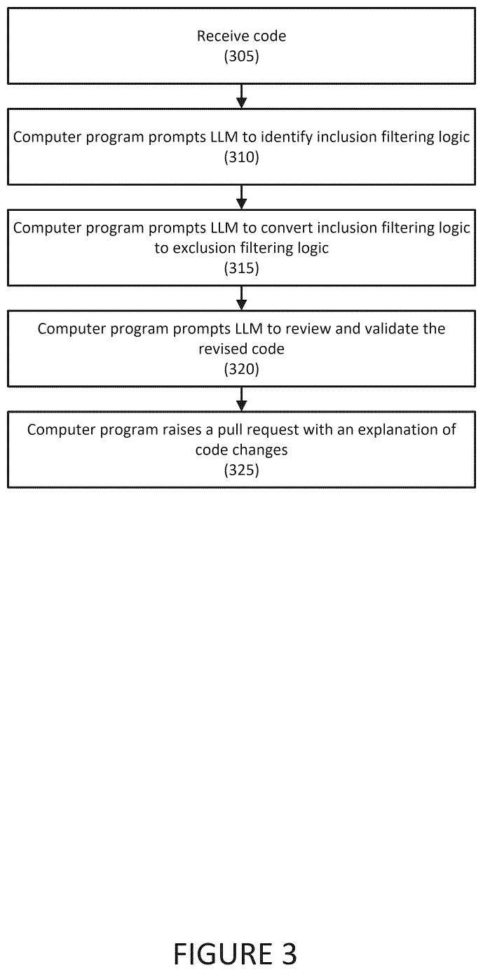

Referring to FIG. 3, a method for checking code for exclusionary filtering logic is disclosed according to an embodiment. Embodiments may check to see of applications use inclusion filtering logic or exclusion filtering logic. Using inclusion filtering logic is undesirable because it means that an application executing that logic knows what it has but not what it is missing. Thus, using exclusionary filtering logic exclusively is the only way to guarantee data completeness, a key requirement of technical data quality.

In step 305, a computer program may receive code from, for example, a code repository, as part of a deployment pipeline, etc.

In step 310, the computer program may provide the code to an LLM and may prompt the LLM to review the code and identify any inclusion filtering logic.

The code may be provided to the LLM with a prompt, such as:
Look for any filtering conditions that specify which data should be included (e.g., WHERE column IN (value1, value2) or WHERE column=value).
Note any conditions that use positive assertions to select data.

In step 315, the computer program may prompt the LLM to convert the inclusion filtering logic to exclusion logic. The LLM may replace any inclusion filtering logic that it finds with exclusion filtering logic and may commit the updated code to Bitbucket and raise a pull request. For example, using only exclusion logic ensures that any data rows that are dropped are explicitly dropped with full knowledge of why they were dropped. The LLM may provide updated code.

An example prompt is as follows:
Change inclusion conditions to exclusion conditions (e.g., WHERE column NOT IN (value1, value2) or WHERE column !=value).
Ensure that the logic correctly excludes the specified data rather than including it.

In step 320, the computer program may prompt the LLM to review and validate the code to ensure that the exclusion logic is correctly implemented and that it achieves the intended filtering effect.

An example prompt is as follows:
Check the modified code to ensure that the exclusion logic is correctly implemented and that it achieves the intended filtering effect.
Validate that the changes do not alter the overall functionality of the data pipeline beyond the filtering logic.

In step 325, the computer program may raise a pull request with an explanation of the code change generated by the LLM.

In one embodiment, the updated code may be stored to a code repository.

Referring to FIG. 4, a method for automatic data quality impact assessment and response is disclosed according to an embodiment.

Embodiments may use AI explainability weights and LLM code reviews discussed to automatically assess the impact of a data quality issue detected in a data attribute and automatically decide upon a calibrated response based upon the impact level. It is not whether a data attribute has changed that is important but whether the data change impacts model performance that is important. For example, if an attribute affects model performance by less than a threshold (e.g., one percent), then a sizeable change in the values of the attribute may not be material to the model performance.

Embodiments may determine how much a data change event to an attribute, or data drift in an attribute, impacts a model. Thus, there is no need wait to run expensive model inference and guardrails to catch errors after the fact. Embodiments may use thresholds for tolerable changes to calculate model behavior rather than thresholds for tolerable change to an attribute.

In step 405, a computer program may receive data.

In step 410, the computer program may provide the data to a policy enforcement point where a data quality dataset may be applied to the data. Data that is validated may be stored, and data that is not validated may be quarantined.

In step 415, the quarantined data may be reviewed by an impact assessor, which may identity a severity level of the quarantined data. There may be four ways to calculate the model impact from a data change, or data drift, which cover four types of models: supervised machine learning, unsupervised machine learning, LLM, and fine-tuned LLM.

For supervised machine learning models, embodiments may proactively use the SHAP and Tree SHAP global explainability values of a model's attributes to calculate the impact of a change to an attribute for all the models in the system. The impact score may be calculated as follows: Global Explainability Percent*Attribute Percent Bad DQ=Impact Score Percent.

Attribute Percent Bad DQ is the percent below a pre-set data quality known key performance indicator for the attribute. For example, if the field is mandatory to populate 100% of the time but the ETL only populates the field 95% of the time, then the Attribute Percent Bad percentage is 5%. If the Global Explainability Percent for the attribute is also 5%, then the Impact Score Percent is 5%×5%=0.25%, a small number that may be acceptable for some use cases.

In addition, for supervised learning, there may be an extra layer of post-inference protection. Post inference, embodiments may use the SHAP, Tree SHAP, and LIME local explainability values of model decisions to determine how much a data quality issue has impacted the average decisions of a model. The impact score may be calculated as follows: Local Explainability Percent for the Bad Attribute*Attribute Percent Bad DQ=Impact Score Percent.

For unsupervised machine learning models that produce feature contribution scores, embodiments may use the scores to calculate the impact of a change to an attribute for all the models in the system. The impact score may be calculated as follows: Feature Contribution Score*Attribute Percent Bad DQ=Impact Score Percent.

Most unsupervised machine learning models use either clustering algorithms such as K-Means and HDBSCAN or anomaly detection algorithms. For such models, the SHAP global explainability values of a model's attributes may be used to calculate the impact of a change to an attribute for all the models in the system. The impact score may be calculated as follows: Global Explainability Percent*Attribute Percent Bad DQ=Impact Score Percent.

For LLMs, perturbation may be used to calculate the impact of a change to an attribute for all the models in the system. The impact score may be calculated as follows: Local Explainability Percent for the Bad Attribute*Attribute Percent Bad DQ=Impact Score Percent.

The impact scores may be classified as High, Medium, or Low. High impact issues prevent persistence or usage of data. Medium impact issues will not stop data usage, but the support team must address them immediately. The support team can address issues rated as Low impact later when schedule permits.

In embodiments, the totality of the DQ situation for all models involved, e.g., how many models are involved and if any of them are crown jewels that whose degradation would be unthinkable, may be considered.

Embodiments may automatically identify critical data elements (CDEs) required by regulators. Regulators require a list of CDEs defined as those attributes that are features used by the AI analytics logic.

In step 420, the severity level may be provided to a response orchestrator, which may track the incident, provide notifications, or may provide messages to automatically shut down a computer application or disable impacted functionality of the application. For example, for low impact, the response orchestrator may notify users that accuracy for a particular analytics function is degraded, or multiple functions are degraded in specific situations, but the system remains operational. It may also create an incident ticket of low priority that will trigger appropriately calibrated site reliability engineer (SRE) attention to fix the incident and update the Error budget.

For medium impact, the response orchestrator may notify users that accuracy for multiple analytics functions is degraded but the system remains operational. It may also create an incident ticket of medium priority that will trigger appropriately calibrated SRE attention to fix the incident and update the Error budget.

For high, or urgent, impact, the response orchestrator may Turn off entire system until the data quality issue is fixed and may also create an incident ticket of urgent priority that will trigger appropriately calibrated SRE attention to fix the incident and update the Error budget.

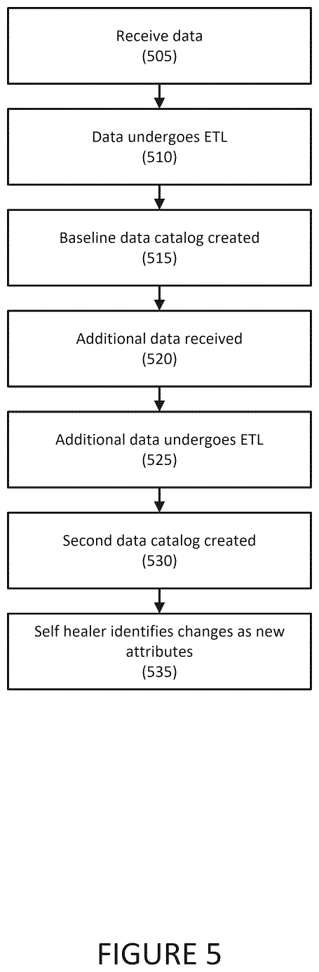

Referring to FIG. 5, a method for automatic sustainability is disclosed according to an embodiment. Embodiments may automatically detect data change events and automatically updates (e.g., self-heals) the data quality process accordingly. For example, if a data producer adds a new data attribute, the computer program may detect the new attribute. A data crawler may be used to create a data catalog baseline and then create a new data catalog after every ETL. If there is a difference between the catalogs, that is this new attribute.

The computer program may profile the values of the attribute with AWS Glue data quality to identify the universe of data quality rules that are needed and create the rules.

Embodiments may also automate the running of the validation rules and reporting, and replays.

In step 505, a computer program may receive data, and in step 510, the data may undergo an ETL process.

In step 515, the computer program may use a data crawler to generate a baseline data catalog.

In step 520, additional data may be received, and in step 525, the additional data may undergo the ETL process.

In step 530, the computer program may use the data crawler to generate a second data catalog.

In step 535, if there are changes between the baseline data catalog and the second data catalog, a self-healer may identify the changes as new attributes. For example, the self-healer may update the data quality process which may include updating the attributes validated, updating the valid values accepted for an attribute, updating the version of the ruleset, notifying consumer applications of the new ruleset version, etc.

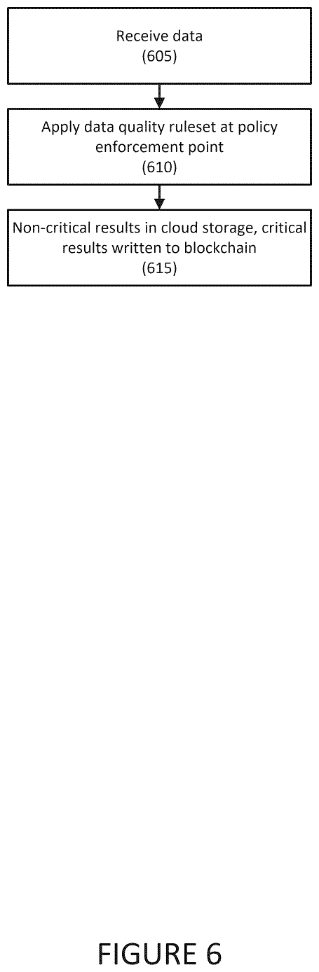

Referring to FIG. 6, a method for automatic blockchain results storage decisioning is disclosed according to an embodiment. For example, embodiments may use the explainability weights output from AI models, and automated LLM code reviews of analytical tools, to automatically assess the risk of a potential data quality issue in an attribute. With the risk assessment, embodiments may automatically determine whether, or not, to store the data quality validation check results for the attribute on an immutable blockchain based upon the data-loss risk versus cost trade-off.

In step 605, a computer program may receive data.

In step 610, the computer program may provide the data to a policy enforcement point where a data quality dataset may be applied to the data.

In step 615, based on the explainability for the attributes, the computer program may store non-critical results in cloud storage, and critical results may be written to a blockchain.

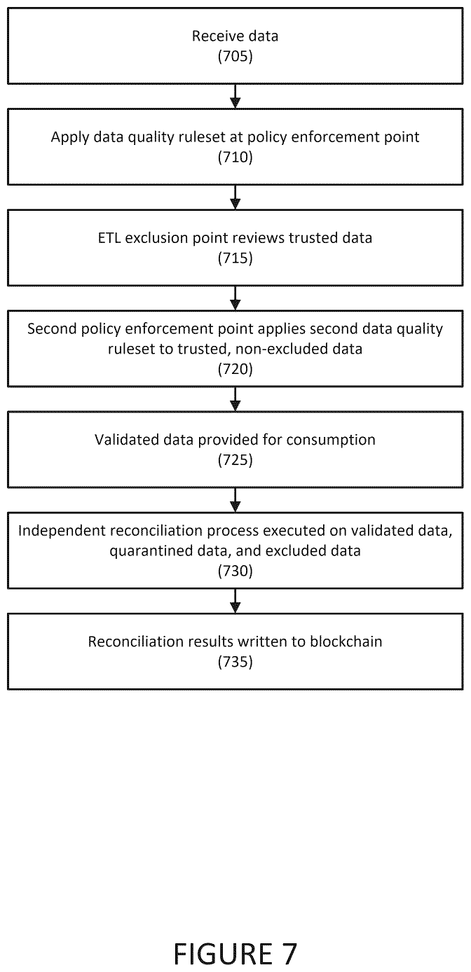

Referring to FIG. 7, a method for independent automatic data completeness checks is disclosed according to an embodiment.

In step 705, data may be received.

In step 710, data may be validated for data quality at an initial policy enforcement point. This may be similar to step 210, above.

Data that is validated may be stored as trusted data, and data that is not validated may be stored as quarantined data.

In step 715, trusted data from the initial policy enforcement point may be reviewed by an exclusion point, such as an ETL exclusion point. An ETL exclusion point may execute exclusion logic to filter data or records that are not needed.

Next, in step 720, the trusted data that is not excluded may be provided to a second policy enforcement point, which may apply a second set of data quality rules. The second set of data quality rules may be an updated version of the data quality rules applied by the initial policy enforcement point.

Data that is not validated by the second policy enforcement point may be stored as quarantined data.

In step 725, data that is validated by the second policy enforcement point may be provided for consumption.

In step 735, an independent reconciliation process may be executed by an independent reconciliation process virtual layer. The process may verify that the Source Data−Exclusions=Target Data. It may create reports comprehensively on the independent reconciliation, such as (1) a report of all data rows and what was done with each row, including (a) recognized rows fed to the analytics, (b) excluded data rows and the condition that triggered the exclusion, and (c) unrecognized rows that have been quarantined for examination to determine if they should be fed to the analytics or excluded; (2) a report of what data was been transformed versus what data was passed straight through, and (3) an independent reconciliation report of rows that are the same in the producer and consumer versus rows that differ or are orphans. Reconciliation may be done in a virtual layer in memory and does not require the input data to be persisted in the independent reconciliation process. The reconciliation output is stored on an unalterable blockchain for later evidencing to auditors and regulators.

In step 735, the reconciliation results may be stored on an immutable blockchain for future evidencing to auditors and regulators.

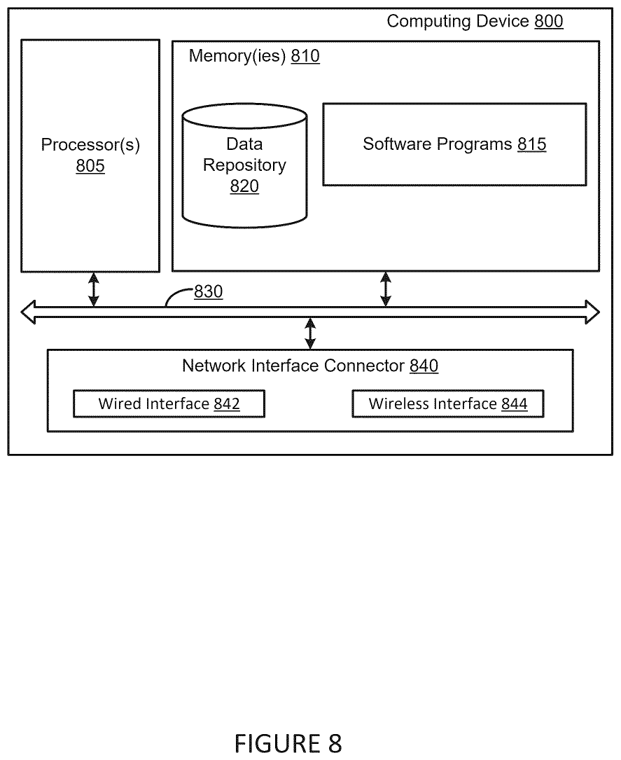

FIG. 8 depicts an exemplary computing system for implementing aspects of the present disclosure. FIG. 8 depicts exemplary computing device 800. Computing device 800 may represent the system components described herein. Computing device 800 may include processor 805 that may be coupled to memory 810. Memory 810 may include volatile memory. Processor 805 may execute computer-executable program code stored in memory 810, such as software programs 815. Software programs 815 may include one or more of the logical steps disclosed herein as a programmatic instruction, which may be executed by processor 805. Memory 810 may also include data repository 820, which may be nonvolatile memory for data persistence. Processor 805 and memory 810 may be coupled by bus 830. Bus 830 may also be coupled to one or more network interface connectors 840, such as wired network interface 842 or wireless network interface 844. Computing device 800 may also have user interface components, such as a screen for displaying graphical user interfaces and receiving input from the user, a mouse, a keyboard and/or other input/output components (not shown).

In one embodiment, the safe space information may be provided to a fraud system and may be used for fraud decisioning.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
receiving, at an initial policy enforcement point in a cloud computing environment, data from a data source;
applying, by the initial policy enforcement point, a first data quality ruleset to the data;
quarantining, by the initial policy enforcement point, data that is not validated by the first data quality ruleset;
generating, by the initial policy enforcement point, a token for validated data that is validated by the first data quality ruleset, wherein the token comprises a checksum for the validated data and an identifier for the first data quality ruleset;
receiving, by a second policy enforcement point and from a consuming computer program, a request for the validated data;
retrieving, by the second policy enforcement point, the token;
determining, by the second policy enforcement point and from the identifier for the first data quality ruleset, that the validated data is valid for a second data quality ruleset;
validating, by the second policy enforcement point, the checksum; and
providing, by the second policy enforcement point, the validated data to the consuming computer program.

2. The method of claim 1, wherein the checksum comprises a hash of the validated data.

3. The method of claim 1, wherein the step of validating the checksum comprises:
generating, by the second policy enforcement point, a second checksum on the validated data; and
validating, by the second policy enforcement point, that the checksum and the second checksum are the same.

4. The method of claim 1, wherein the token further comprises an assessment of a data quality of the validated data.

5. The method of claim 1, wherein the second data quality ruleset is newer than the first data quality ruleset.

6. The method of claim 1, further comprising:
receiving, by the initial policy enforcement point and the second policy enforcement point, explainability weights for the second data quality ruleset; and
updating, by the initial policy enforcement point and the second policy enforcement point, data quality checks of attributes in the data based on the explainability weights.

7. The method of claim 6, wherein the explainability weights impact an amount of time for each data quality check.

8. The method of claim 1, further comprising:
applying, by the second policy enforcement point, the second data quality ruleset to the validated data;
quarantining, by the second policy enforcement point, validated data that is not validated by the second data quality ruleset; and
providing, by the second policy enforcement point, the validated data that is validated by the second data quality ruleset to the consuming computer program.

9. A method, comprising:
receiving, by a computer program, computer code;
prompting, by the computer program, a large language mode (LLM) to review the computer code for instances of inclusionary filtering logic;
prompting, by the computer program, the LLM to replace the instances of inclusionary filtering logic in the computer code with exclusionary filtering logic, wherein the LLM replaces the instances of inclusionary filtering logic in the computer code with exclusionary filtering logic resulting in updated computer code; and
receiving, by the computer program, the updated computer code from the LLM.

10. The method of claim 9, further comprising:
prompting, by the computer program, the LLM to validate the updated computer code to ensure that an overall functionality of the computer code is not changed.

11. The method of claim 9, wherein the computer code is received as part of a deployment pipeline.

12. The method of claim 9, further comprising:
committing, by the computer program, the computer code from the LLM to a code repository.

13. A method, comprising:
receiving, by an initial policy enforcement point, source data;
applying, by the initial policy enforcement point, a first data quality ruleset to the source data;
quarantining, by the initial policy enforcement point, source data that is not validated by the first data quality ruleset as first quarantined data;
reviewing, by an exclusion point, source data that is validated by the first data quality ruleset;
excluding, by the exclusion point, a subset of the validated source data as excluded data;
applying, by a second policy enforcement point, a second set of data quality rules to validated data that is not excluded data;
quarantining, by the second policy enforcement point, validated source data that is not excluded data that is not validated by the second data quality ruleset as second quarantined data;
providing, by the second policy enforcement, the validated source data that is not excluded data as target data;
validating, by an independent reconciliation process virtual layer, that the source data minus the first quarantined data, the excluded data, and the second quarantined data equals the target data; and
generating by the independent reconciliation process virtual layer, a reconciliation report based on the validation.

14. The method of claim 13, further comprising:
writing, by the independent reconciliation process virtual layer, the reconciliation report to a blockchain.

15. The method of claim 13, wherein the reconciliation report comprises a report of all data rows in the source data and what was done with each row.

16. The method of claim 13, wherein the exclusion point comprises an extract-transfer-load exclusion point.

17. The method of claim 13, wherein the exclusion point executes exclusion logic to exclude the subset of the validated data.
